(19) United States
(12) Patent Application Publication
(10) Pub. No.: US 2012/0057986 A1
(43) Pub. Date: Mar. 8, 2012

(54) PRODUCTION METHOD OF IMPELLER APPLIED TO SUPERCHARGER

(75) Inventors: Tomohiro Inoue, Tokyo (JP); Yukio Takahashi, Tokyo (JP); Yoshimitsu Matsuyama, Tokyo (JP)

(73) Assignee: IHI Corporation, Tokyo (JP)

(21) Appl. No.: 13/319,275

(22) PCT Filed: May 20, 2010
(86) PCT No.: PCT/JP2010/058528

§ 371 Date: Nov. 7, 2011

(30) Foreign Application Priority Data
May 20, 2009 (JP) 2009-122057

(51) Int. Cl. F01D 5/14; B22F 3/24; C04B 35/64

(52) U.S. Cl. 416/241 B; 264/645; 419/28

(57) ABSTRACT

An impeller comprising a wheel portion extending in an axial direction and a plurality of blades arranged around the wheel portion is produced by assembling a mold divisible into a plurality of parts having a cavity adapted for forming an outer profile of the impeller, injecting a kneaded matter including powder of a metal or a ceramic and binder to mold a green body, degreasing and sintering the green body to obtain a sintered body, embedding the sintered body into a die having a cavity adapted for modifying the outer profile of the impeller, and pressurizing the die to modify the outer profile of the impeller.

### TECHNICAL FIELD

The present invention relates to a method of production of impellers applied to superchargers.

### BACKGROUND ART

Superchargers are often used in order to feed greater amount of air into internal combustion engines. A supercharger is comprised of a compressor and, by operating the compressor, pressurizes and supplies air to an engine. In a case of a supercharger of a so-called turbocharger type, a turbine receiving exhaust from an engine is provided and then energy extracted from the exhaust by means of the turbine drives a compressor. On the other hand, in a case of a supercharger in a limited sense, a crankshaft of an engine is coupled with and then drives a compressor.

A turbine of a turbocharger is comprised of an impeller for converting force of gas flow into rotational force. The impeller is in general comprised of a wheel about a rotational axis and a plurality of blades extending radially from the wheel. Each blade is inclined relative to its axial direction and further has an airfoil profile so as to receive gas flow and then rotate, thereby extracting energy from exhaust gas. In order to achieve excellent aerodynamic properties, it is required to realize such a complex shape in high precision. Further as the turbine performs high-speed rotation up to several hundred-thousands rpm, slight deformation in shape shall cause abnormal rotation. Thus production thereof requires very high precision, and its permissible tolerance would be, although depending on locations, merely several tens micrometer or such.

On the other hand, as the turbine impeller is exposed to high-temperature exhaust gas, it must have resistance to heat of 800 degrees C. for example. Therefore heat-resistant alloys shall be applied thereto. These alloys are, however, inherently hardly machinable and therefore ordinary processes which considerably rely on machining could be hardly used in its production. In order to reduce reliance on machining, integral molding based on precision casting for example is used in production of turbine impellers, however, sharp shapes such as edges of blades cannot be realized merely by casting. Thus machining cannot be omitted even if precision casting is used.
Japanese Patent Application Laid-open No. 2001-254627 discloses a related art.

### DISCLOSURE OF INVENTION

The present inventors have been studying application of powder injection molding to production of turbine impellers so as to produce complex shapes without any finishing processes. The inventors have consequently produced satisfactory results in realizing thin and sharp shapes such as blades but found out a problem that slight deformation may readily occur in the course of sintering. The present invention has been achieved to solve the problem.

According to a first aspect of the present invention, a method of production of an impeller comprising a wheel portion extending in an axial direction and a plurality of blades arranged around the wheel portion comprises assembling a mold divisible into a plurality of parts having a cavity adapted for forming an outer profile of the impeller, injecting a kneaded matter including powder of a metal or a ceramic and binder to mold a green body, degreasing and sintering the green body to obtain a sintered body, embedding the sintered body into a die having a cavity adapted for modifying the outer profile of the impeller, and pressurizing the die to modify the outer profile of the impeller.

According to a second aspect of the present invention, an impeller comprising a wheel portion extending in an axial direction and a plurality of blades arranged around the wheel portion is produced by assembling a mold divisible into a plurality of parts having a cavity adapted for forming an outer profile of the impeller, injecting a kneaded matter including powder of a metal or a ceramic and binder to mold a green body, degreasing and sintering the green body to obtain a sintered body, embedding the sintered body into a die having a cavity adapted for modifying the outer profile of the impeller, and pressurizing the die to modify the outer profile of the impeller.

### BRIEF DESCRIPTION OF DRAWINGS

FIG. 1 is a drawing illustrating a process of injection molding of an impeller in accordance with an embodiment of the present invention, which shows a cross sectional view of a mold and a green body therein.

FIG. 2 shows a schematic cross sectional view illustrating a step of degreasing the green body.

FIG. 3 shows a schematic cross sectional view illustrating a step of sintering the degreased green body.

FIG. 4 shows a cross sectional view illustrating a step of modifying in accordance with the embodiment.

FIG. 5 shows a cross sectional view of the impeller in accordance with the embodiment.

FIG. 6 shows a cross sectional view illustrating change in shape of the impeller in the step of modifying, where (a) shows one prior to the modifying and (b) shows one after the modifying.

### BEST MODE FOR CARRYING OUT THE INVENTION

Exemplary embodiments will be described hereinafter with reference to the appended drawings. For the convenience of explanation, directions indicated as L and R in these drawings will be expressed as a left direction and a right direction, respectively, and those indicated as U and D will be expressed as an upper direction and a lower direction, respectively, however, these expressions are not limiting to the invention.

An impeller according to an embodiment of the present invention is applicable to a turbocharger for a vehicle but may be of course applicable to other uses. The following description will be given to a case of an impeller of a turbocharger for the convenience of explanation.

A turbocharger is in general comprised of a turbine portion, a shaft portion and a compressor portion. The turbine impeller has a roll of, at the turbine portion, extracting energy from exhaust gas from an engine and converting it into a rotational energy. The rotational energy is transmitted to the compressor portion via a shaft of the shaft portion and thereby at the compressor portion air is compressed and fed to an engine.

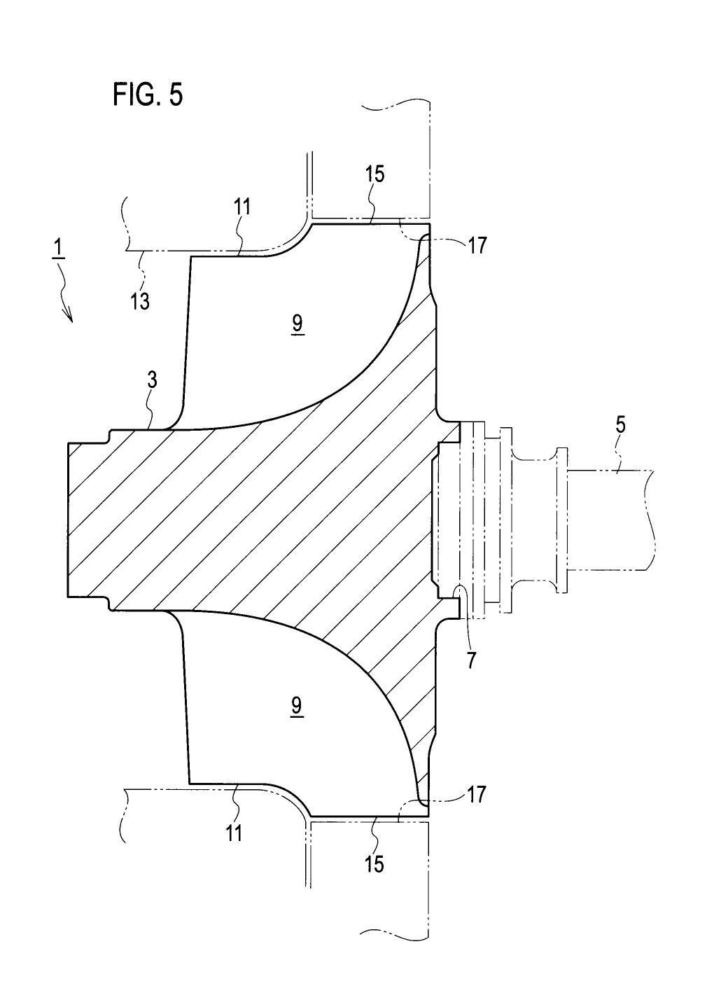

Referring to FIG. 5, an axially left end of the shaft is coupled with a seat 7 at a left end of a turbine impeller 1 so as to concurrently rotate about an axis. This coupling is made by welding but may be made by any other means such as blazing or tight-fitting if possible.

The turbine impeller 1 is formed of a metal or a ceramic formed in a unitary body by powder injection molding described later, and is comprised of a wheel portion 3 extending in the axial direction and a plurality of blades 9 radially extending from the wheel portion 3. While a periphery of the blades 9 is surrounded by a shroud 13 of a turbine housing, respective outer peripheries of the blades 9 retain proper gaps relative to an inner periphery of the shroud 13 so as to avoid interference with its rotation. Further the shroud 13 has a throat configured to conduct the exhaust gas from the engine to the blade 9, which circumferentially surrounds sides shown in the right of the blades 9. The throat may have variable nozzles 17 regulative of these apertures. The exhaust gas is conducted through the throat to respective gaps between the blades 9, gives rotational energy to the turbine impeller 1, and is thereafter exhausted to an exhaust port at the left of FIG. 5.

The plurality of blades 9 is formed in a unitary body with the wheel portion 3 and is arranged at even intervals around the axis. If possible, evenness may not be indispensable. Each blade 9 is inclined relative to the axial direction so as to receive the gas flow and then produce torque, and further preferably has an airfoil shape. Thereby the turbine impeller 1 extracts energy from the exhaust gas and is thereby capable of driving the shaft 9. Each outer periphery 11 of each blade 9 is made close to the shroud 13 so as to minimize detour of the gas flow.

As described above, the wheel portion 3 at the right end has the seat 7. The seat 7 may be a recess slightly receding from the right end of the wheel portion 3 or a pit considerably entering into the wheel portion 3. Alternatively, if possible, it may be a through hole reaching the left end. Preferably a peripheral wall projecting rightward from the edge of the seat 7 is provided. In either case, the seat 7 is so structured as to fit with a left end of the shaft 9.

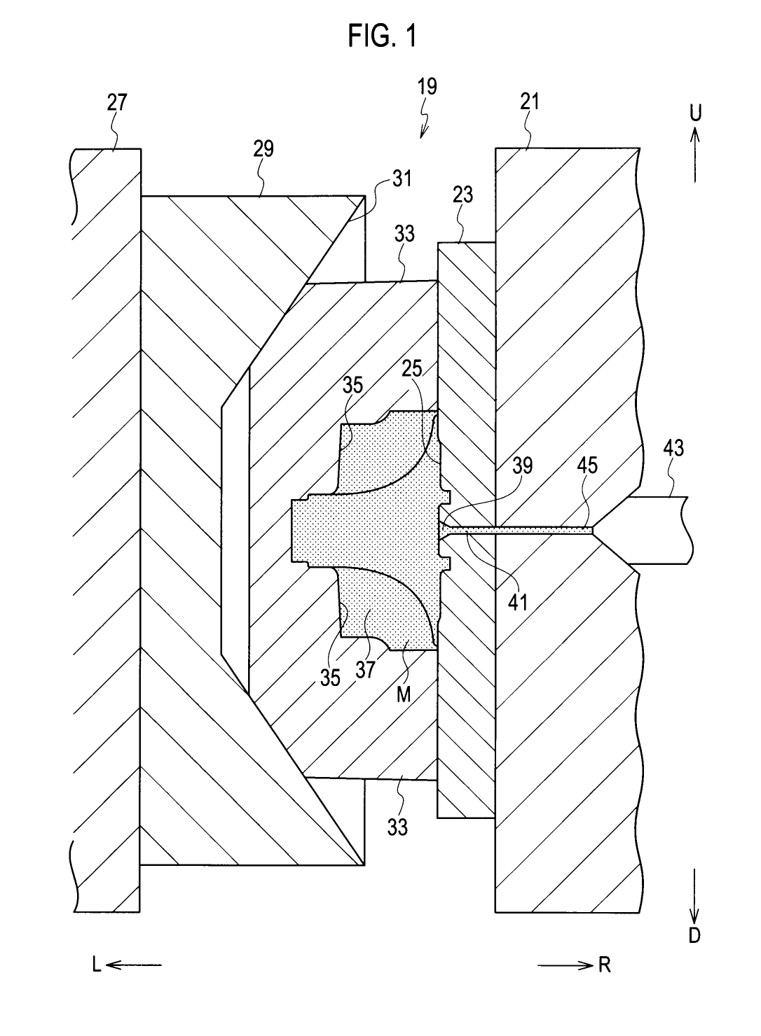

The turbine impeller 1 is produced by powder injection molding. The powder injection molding will be described hereinafter with reference to FIG. 1.

In the powder injection molding used is a mold 19 and an injection molding machine. The injection molding machine is comprised of a fixed frame 21 for supporting the mold 19 and a movable frame 27. Further, the injection molding machine is comprised of an injector not shown in the drawing, an injection nozzle 43, an actuator for driving the movable frame 27, and others.

The mold 19 is formed of a proper metal such as SKD11 (JIS G4404), and is divisible in a proper way. In the example shown in FIG. 1, the mold 19 is divisible into a platform 23 and an outer mold 33 which is further divisible into parts arranged in a circumferential direction. A combination of a molding surface 25 of the platform 23 and a molding surface 35 of the outer mold 33 defines a cavity 37 adapted for forming an outer profile of the turbine impeller 1. The platform 23 is further comprised of a structure adapted for forming the seat 7. Because volume contraction by 20% or so will occur in the course of sintering, the mold 19 and the platform 23 are designed in light of such volume contraction.

A block 29 is preferably made interposed between the mold 19 and the movable frame 27. The block 29 has a conically concave surface 31 and the mold 19 has a taper surface corresponding thereto. As the concave surface 31 abuts on the taper surface and the movable frame 27 gives pressure to the mold 19, respective parts of the outer mold 33 mutually come into tight contact in the circumferential direction. Further preferably, an actuator is provided so as to move the respective parts of the outer mold 33 in the radial direction. The actuator may be so configured as to drive the outer mold 33 in synchronism with the movable frame 27.

The fixed frame 21 is further comprised of a spool 97 in communication with the injection nozzle 43 and the platform 23 is comprised of a runner 41 and a gate 39 in communication with the spool 97 so as to let injected matter pass therethrough. The runner 41 is so provided as to penetrate the platform 23. The gate 39 opens at the right end of the cavity 37. The gate 39 and the spool 97 may be provided in the outer mold 33 instead of, or in addition to, the platform 23.

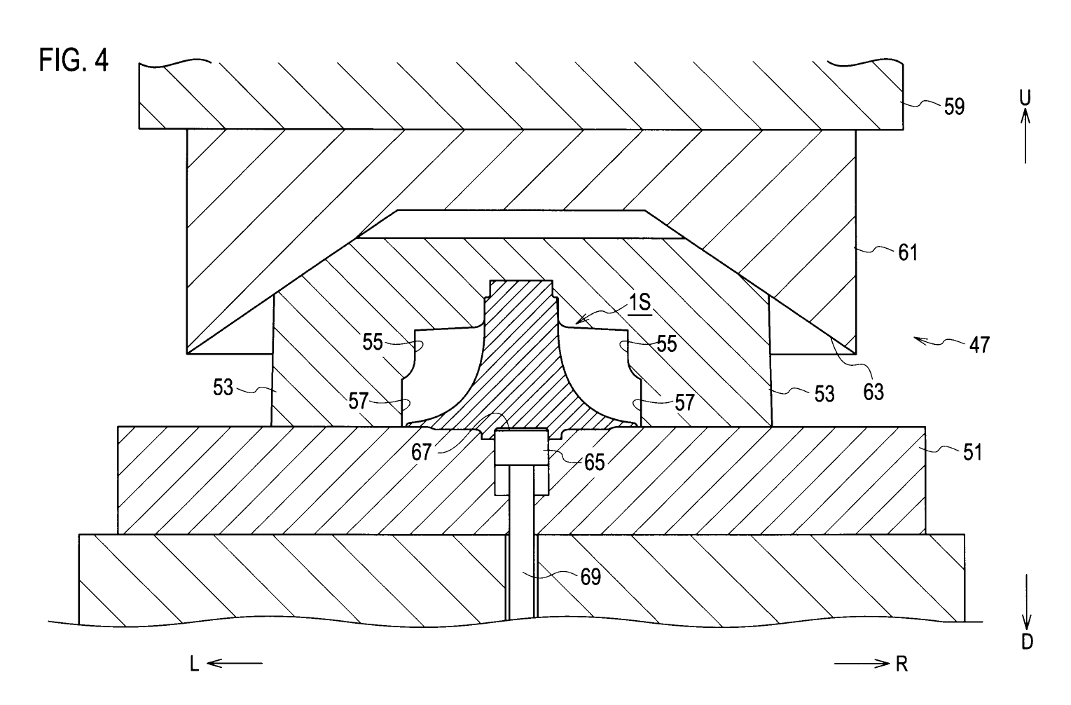

After the powder injection molding and sintering, in general, a step of modifying will be carried out in order to modify its surface or the shape to adjust its dimensions to predetermined dimensions and permissible tolerances. A device used in the modifying step will be described hereinafter with reference to FIG. 4.

In the modifying step used are a die 47 and a press. A general press having a proper capacity may be used as the press. The press is comprised of a block for supporting the die 47 and a ram 59 vertically movable with pressurizing force.

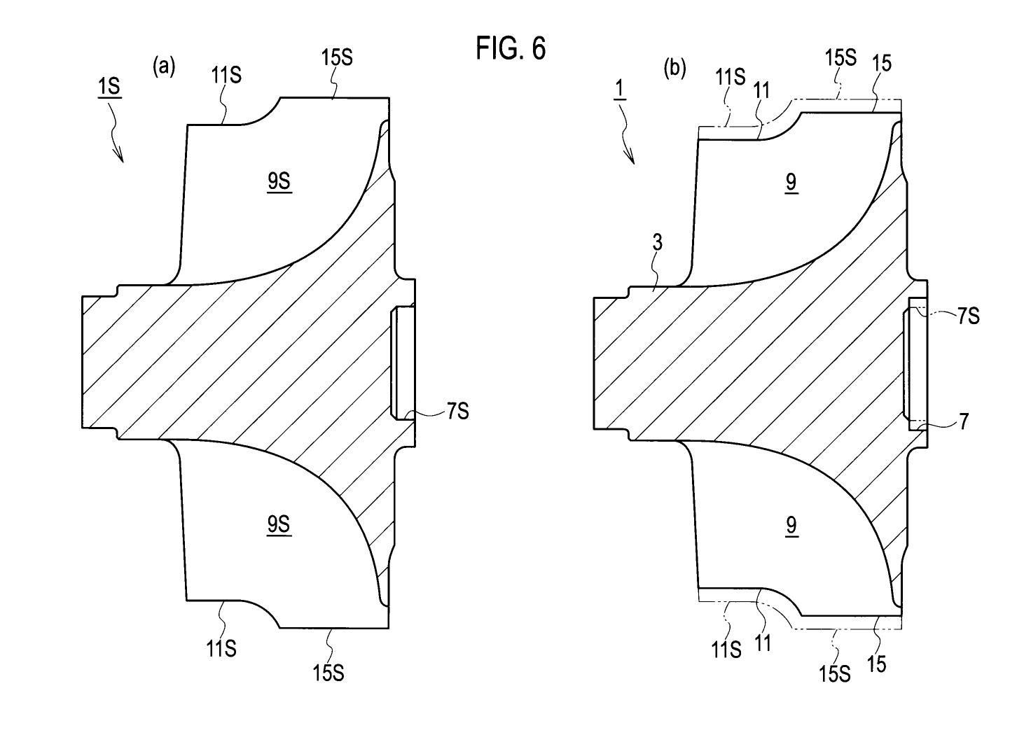

The die 47 is formed of a proper metal such as SKD11 (JIS G4404), and is divisible in a proper way. In the example shown in FIG. 4, the die 47 is divisible into a pedestal 51 and an outer die 53 which is further divisible into elements arranged in a circumferential direction. The pedestal 51 of the die 47 is placed on the block and the outer die 53 is placed further on the pedestal 51. A combination of an upper surface of the pedestal 51 and an inner surface 53 of the outer die defines a cavity. The cavity has a shape corresponding with an outer profile of a finally finished shape of the turbine impeller 1. Alternatively, any play relative to the final shape may be given to locations not related to the modifying. More specifically, the cavity has a shape adapted for modifying the outer shape of the turbine impeller 1S after sintering. The outer die 53 is divided into a plurality of elements in the circumferential direction and the elements are respectively inserted into respective gaps between the blades 9S, thereby each pair of adjacent elements has each blade 9S held in the pair. A location 55 in each element 5 divided from the outer die 53 corresponds to a location 11S (see FIG. 6(a)) in a blade 9S, and a location 57 corresponds to a location 15S (see FIG. 6(a)) in the blade 9S.

A block 61 is preferably made interposed between the die 53 and the ram 59. The block 61 has a conically concave surface 63 and the die 53 has a taper surface corresponding thereto. As the concave surface 63 abuts on the taper surface and the ram 59 is pressed down, force acts on the elements in a direction where the respective elements of the outer die 53 come in close contact with each other. Alternatively, an actuator for driving the elements in radial directions may be provided.

A punch 65 adapted to a shape of the seat 7 is preferably provided on the pedestal 51. The punch 65 is connected with a rod 69 penetrating the pedestal 51 and is driven by an actuator such as a hydraulic cylinder to move up and down. The punch 65 presses a location 67 in the sintered body 1S and at the location 67 realizes the shape of the seat 7.

Production of the turbine impeller 1 follows steps as described below.

First injection matter M is kneaded. To the injection matter M preferably applied is a mixture of powder of a metal or a ceramic and a binder.

As the metal or ceramic powder used is powder of any properly selected material depending on required properties. Taking thermal resistance required to the turbine impeller into consideration, powder of a Ni-based heat-resistant alloy (INCONEL 713C, IN 100, MAR-M246 or such), silicon nitride, and a ceramic such as SIALON can be exemplified.

As a binder, any publicly known binder for powder injection molding can be used. As such a binder for powder injection molding, any of thermoplastic resins such as polystyrene or polymethylmethacrylate along with any additive such as paraffin wax added thereto can be preferably used. Such a binder retains a shape of injected matter after injection and solidification until a degreasing step described later, and further decomposes and evaporates at the degreasing step so as to leave no traces in the sintered body.

The mixture of the metal or ceramic powder and the binder is heated up to from 100 to 150 degrees C. for example and then kneaded. The temperature for kneading may be properly selected depending on a composition of the kneaded matter. After kneading, proper cooling is executed and then the injection matter M is obtained.

After preparing the injection matter M, the platform 23 and the respective parts of the outer mold 33 are placed on the fixed frame 21. Any publicly known parting agent may be applied on these parts in advance. By driving the actuator, the outer mold 33 is moved radially inward so as to have the respective parts of the outer mold 33 abut mutually. Next the block 29 is made to abut on them and pressed by means of the movable frame 27. Movement of the outer mold 33 by the actuator may be synchronized with movement of the movable frame 27. Thereby the outer mold 33 and the platform 23 are made in close contact with each other so that the mold 19 is completed.

The injection matter M is heated so as to be given sufficient fluidity, from 160 to 200 degrees C. for example, and is then injected through the injection nozzle 43 into the mold 19 with a pressure of about 100 MPa. The heating temperature and the injection pressure may be properly selected depending on the composition of the kneaded matter. By proper cooling, the injected matter is solidified and then a green body 1F is formed.

Next by driving the actuator, the movable frame 27 is detached from the mold 19 and further the outer mold 33 is detached from the green body 1F.

The formed green body 1F is, as described above, made greater by about 20% in volume ratio as compared with the final shape as contraction by sintering is taken into consideration. While the green body 1F is comprised of a portion 7F which will be the seat 7 after sintering, it is also made greater by about 20% in volume ratio.

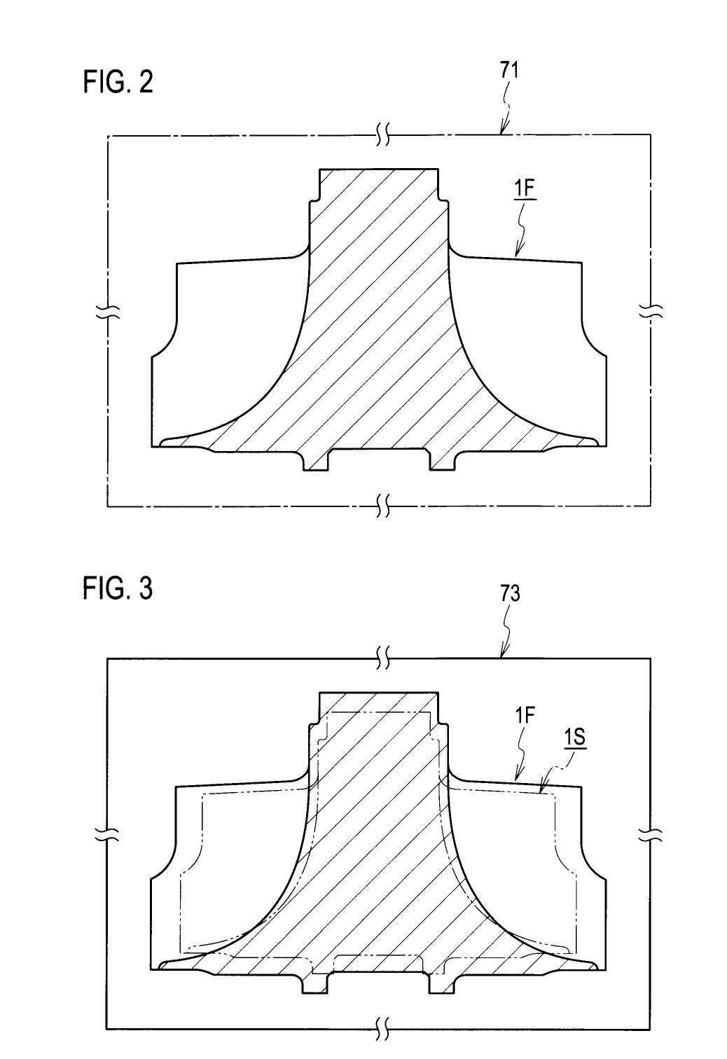

Referring to FIG. 2, the green body 1F is introduced into a proper atmosphere-controllable furnace 71. Nitrogen gas is introduced into the furnace and then the nitrogen atmosphere is kept. The interior of the furnace is heated to a proper high temperature not beyond 800 degrees C. by means of any proper heating means such as a carbon heater and then the temperature is kept for 30 minutes or longer. By such a degreasing step, the binder contained in the green body 1F is melted, decomposed and removed by evaporation.

The degreasing step can be executed by means of any publicly known method instead of the aforementioned method, such as eluting with a proper solvent.

Referring to FIG. 3, the green body 1F after degreasing is introduced into a proper atmosphere-controllable furnace 73. The interior of the furnace 73 is placed under a proper depressurized condition and then heated to a proper sintering temperature of from 1000 to 1500 degrees C. for example by means of any proper heating means such as a carbon heater. The sintering temperature is kept for proper duration, 1 hour or longer for example. By such a sintering step, sintering progresses as well as the green body 1F contracts. As a result, a sintered body 1S as shown by double-dotted lines in FIG. 3 is obtained. The sintered body 1S is made smaller by 20% in volume ratio as compared with the green body 1F and is substantially identical to the final shape but includes slight deformations associated with sintering.

In the above descriptions, the degreasing step and the sintering step are independent but may be executed continuously.

After proper cooling, nitrogen or such is introduced into the furnace, thereby the interior of the furnace 73 is made at the atmospheric pressure. Then the sintered body 1S is taken out. Next the sintered body 1S is embedded in the die 47 as shown in FIG. 4.

The punch 65 is at first in a position retracted downward. The sintered body 1S is laid on the pedestal 51 and positioned in place by using consistency between the structure of its lower surface and the structure of the pedestal 51. Next the elements of the outer die 53 are respectively inserted into the gaps between the blade 9S to assemble the outer die 53. The block 61 is made interposed so as to abut its taper surface on the concave surface 63, and then the ram 59 is made move down. To further press down the ram 59, force acts on the elements in a direction where the respective elements of the outer die 53 come in close contact with each other, thereby the sintered body 1S is totally pressurized. At this state, simultaneously, the rod 69 is made to move up so that the punch 65 further pressurizes the sintered body 1S.

In this modifying step, by means of the force in the direction where the elements of the outer die 53 come in close contact with each other, deformations of the respective blades 9 are reformed, thereby adjusting these surfaces and shapes to the final shape, and as well pressurizing the respective blades 9 in directions perpendicular to these surfaces. The respective elements of the outer die 53 respectively abut on the locations 11S, 15S of the respective blades 9 so as to radially modify these locations and also radially pressurize them. The outer die 53 simultaneously pressurizes the peripheral surface of the wheel portion 55 radially inwardly and the upper surface of the wheel portion 55 downward. Further the lower surface of the wheel portion 55 is pressurized upward by the pedestal 51 and the punch 65. More specifically, the surfaces of the sintered body 1S are quasi-isotropically thoroughly pressurized. This modifying step may be executed either in a cold condition or in a proper warm condition.

After the aforementioned modifying step, the punch 65 is made to move down and the ram 59 is made to move up. When the respective elements of the outer die 53 move radially outward, the modified turbine impeller 1 is taken out.

According to the present embodiment, without finishing by machining, a turbine impeller in which a complex shape is realized in high precision can be produced. The embodiment, as compared with precision casting, enables high precision particularly in portions of thin and sharp shapes such as blades. As it does not depend on machining, the embodiment enables high productivity even if objects are of hardly machinable materials such as heat-resistant alloys.

Further, as the object is totally pressurized at the time of modifying, defects such as small pores will be, even if exist, squashed and then dissolved. Further this pressurization leaves compression stress in turbine impellers, in particular surfaces thereof. This residual stress counteracts tensile stress in the turbine impellers caused by high-speed rotation, thereby contributing improvement of fatigue life.

The present embodiment may be preferably applied to not only turbine impellers but also various machine components which need precision.

Although the invention has been described above by reference to certain embodiments of the invention, the invention is not limited to the embodiments described above. Modifications and variations of the embodiments described above will occur to those skilled in the art, in light of the above teachings.

### INDUSTRIAL APPLICABILITY

A method for producing a turbine impeller in which a complex shape is realized in high precision without finishing by machining is provided.

1. A method of production of an impeller having a wheel portion extending in an axial direction and a plurality of blades arranged around the wheel portion, comprising:
assembling a mold separable into a plurality of parts having a cavity adapted for forming an outer profile of the impeller;
injecting a kneaded matter including powder of a metal or a ceramic and binder to mold a green body;
degreasing and sintering the green body to obtain a sintered body;
embedding the sintered body into a die having a cavity adapted for modifying the outer profile of the impeller; and
pressurizing the die to modify the outer profile of the impeller.

2. The method of claim 1, wherein the mold comprises a platform and an outer mold divisible into a plurality of parts arranged in a circumferential direction.

3. The method of claim 1, wherein the die comprises a pedestal and an outer die divisible into a plurality of elements arranged in a circumferential direction.

4. The method of claim 3, wherein the elements are so structured as to be inserted into gaps between the blades.

5. An impeller comprising a wheel portion extending in an axial direction and a plurality of blades arranged around the wheel portion, the impeller being produced by:
assembling a mold divisible into a plurality of parts having a cavity adapted for forming an outer profile of the impeller;
injecting a kneaded matter including powder of a metal or a ceramic and binder to mold a green body;
degreasing and sintering the green body to obtain a sintered body;
embedding the sintered body into a die having a cavity adapted for modifying the outer profile of the impeller; and
pressurizing the die to modify the outer profile of the impeller.
